(19) United States
(12) Patent Application Publication
(10) Pub. No.: US 2005/0178437 A1
(43) Pub. Date: Aug. 18, 2005

(54) Pressure relief valve embedded in a molded rubber seal

(75) Inventor: Jeffrey A. Schultz, Pittsville, VA (US)

Correspondence Address: BRINKS HOFER GILSON & LIONE, P.O. BOX 10395, CHICAGO, IL, 60610, US

(73) Assignee: Schrader-Bridgeport International, Inc.

(21) Appl. No.: 10/780,175

(22) Filed: Feb. 17, 2004

(51) Int. Cl. F16K 17/04

(52) U.S. Cl. 137/224

(57) ABSTRACT

A pressure relief valve includes a valve insert having an opening at a first end and a pathway extending towards the opening from a second end of the valve insert. An adjustment member is received within in the opening of the valve insert. The valve insert and the adjustment member define a chamber adjacent the pathway. The adjustment member includes a throughway. A bearing element is within the chamber and adjacent the pathway. A width of the bearing element is larger than a width of the pathway. A spring is within the chamber and is under compression and in line with the bearing element. A cushioning member surrounds the valve insert and allows the flow of pressurized fluid. The spring exerts a force on the bearing element such that the bearing element is biased against the pathway and forms a seal between the chamber and the pathway.

### BACKGROUND

This invention relates to inflatable tires mounted on wheels, specifically to the inclusion of a pressure-limiting relief valve to actively limit the pressure in the tire. The invention further relates to a method of installing such pressure relief valves.

When a tire on a vehicle is pressurized, it will be pressurized to a predetermined pressure. For the safety of the tire mounting technicians and vehicle occupants, the tire should not be pressurized past a maximum pressure. Moreover, the tires should not become over pressurized in service due to other conditions such as, by way of example, excessive temperature. Once a tire has been pressurized, it will often be advantageous to obtain information regarding the tire pressure and any fluctuations therein. A tire pressure monitoring system may be used to collect data related to tire pressure and tire conditions, typically via a pressure monitor and a tire valve that is attached to a tire rim. The pressure monitor may include electronic circuitry that transmits the collected information to a remote receiver, which in turn conveys the information to the driver of the vehicle. These systems, however, often will not provide information regarding pressure when the tire pressure exceeds a predetermined pressure. Thus, no data regarding the tire pressure will be provided when the tire is over pressurized.

A pressure relief valve will be utilized to provide relief when inflation pressure exceeds a predetermined maximum pressure, thus reducing risk of damage to the tire and/or the vehicle. The valve typically will be inserted into an opening in the tire rim of the wheel. Also, because a portion of the valve will remain on the outside of the rim when it is inserted into the opening, the valve may be exposed to tampering or similar damage. Accordingly, it would be desirable to have a pressure relief valve that overcomes the disadvantages and limitations described above.

### BRIEF SUMMARY

In order to address the need for a pressure relief device in the wheel, a tire pressure relief valve is described below. According to one aspect of the pressure relief valve, a valve insert is disclosed having an opening at a first end and a exhaust pathway extending from the other end of the valve insert. An adjustment member is received within in the opening of the valve insert, and the valve insert and the adjustment member define a chamber adjacent the pathway. A bearing element is within the chamber and adjacent the pathway. A width of the bearing element is larger than a width of the pathway. A spring is within the chamber and is under compression and in line with the bearing element. A sealing member is contained within the valve insert, sealing the valve exhaust passage when the pressure is below the setting, and allowing flow of pressurized fluid when the pressure is above the set point. The spring exerts a force on the bearing element such that the bearing element is biased against the pathway and forms the controlling force for the described seal.

According to another aspect of the invention, a pressurized tire is disclosed and includes a tire rim. A pressure relief valve is attached with and in fluid communication with the tire rim. The pressure relief valve includes a valve insert having a first end, at least one opening, and a pathway extending towards the opening from a second end of the valve insert. An adjustment member is received within in the opening of the valve insert. The valve insert and the adjustment member define a chamber adjacent the pathway. The adjustment member includes a throughway. A bearing element is within the chamber and adjacent the pathway. A width of the bearing element is larger than a width of the pathway. A spring is within the chamber and is under compression and in line with the bearing element. A cushioning member surrounds the valve insert and allows the flow of pressurized fluid. The spring exerts a force on the bearing element such that the bearing element is biased against the pathway and forms a seal between the chamber and the pathway.

An aspect of the invention also includes a method for inserting a pressure relief valve into a tire. The method includes inserting a pressure relief valve having a cushioning member into an opening of a tire rim so that a detent of the cushioning member passes an inner wall of the tire rim and so that a flange of the cushioning member contacts an outer wall of the tire rim.

Although the pressure relief valve described herein is discussed for use in conjunction with tires, it will be readily understood by those skilled in the art that such pressure relief valves may also be used with other types of commodities where it is desirable to provide pressure relief when a predetermined pressure is exceeded.

### BRIEF DESCRIPTION OF THE DRAWINGS

FIG. 1 is a sectional view of an embodiment of a pressure relief valve;

FIG. 2 is a view of a pressure relief valve inserted into a tire rim; and

FIG. 3 is a section view of a second embodiment of a pressure relief valve.

### DETAILED DESCRIPTION OF THE DRAWINGS AND THE PRESENTLY PREFERRED EMBODIMENTS

Normally, when pressurizing a tire on a vehicle, the tire should not be pressured past a predetermined pressure. This pressure can be any value, depending on considerations such as the type of tire used and any standards or regulations in place. Generally, however, it is desirable that a tire will be pressurized to a pressure of over 50 pounds per square inch (psi). In this example, if the pressure of the tire rises above 50 psi, the tire will become over pressurized, which may result in damage to the tire and/or the vehicle. If the tire pressure exceeds the predetermined pressure, relief may be provided via the pressure relief valve.

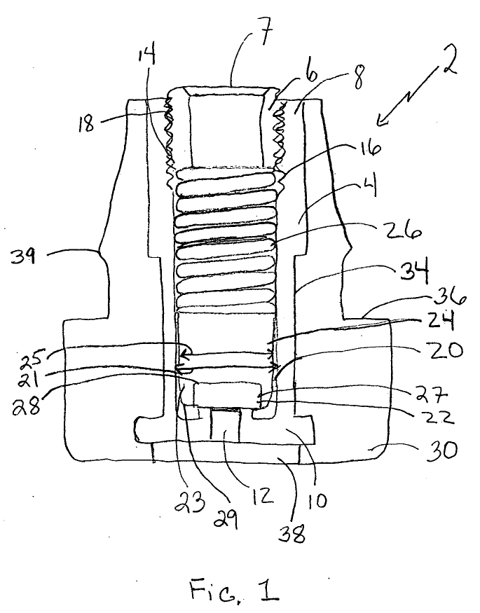

Turning now to the drawings, FIG. 1, the pressure relief valve 2 includes a valve insert 4 and an adjustment member 6. The valve insert 2 includes a first end 8, a second end 10 opposite the first end 8, and a pathway 12 that extends from a second end 10 of the valve insert 4 towards the first end 8.

The adjustment member 6 is received within an opening 14 at the first end 8 of the valve insert 4 and includes a throughway 7 through which pressurized fluid may pass. In a preferred embodiment, the valve insert 4 preferably includes interior threads 16 that engage with exterior threads 18 on the adjustment member, although in other embodiments the valve insert 4 and adjustment member 6 may be otherwise attached, such as through the use of fasteners or the like. The interior threads 16 of the valve insert engage with the exterior threads of the adjustment member so that the adjustment member is positioned at a predetermined position in order to bias a spring 26.

The valve insert 4 preferably is made of brass, although in other embodiments, the valve insert may be made of steel, an aluminum alloy, or any other type of suitable alloy. In the present embodiment, the adjustment member 6 is also made of brass, but, as with the valve insert, may also be made of steel, an aluminum alloy, or other alloy.

The valve insert 4 and adjustment member 6 together define an enclosed chamber 20 that preferably is adjacent the pathway 12. As shall be described further below, when the valve 2 is in an actuated state, i.e., when the valve provides pressure relief, the chamber 20 and the pathway 12 are in fluid communication.

A bearing element 23 and a spring 26 are located within the chamber 20. The bearing element 23 is adjacent the pathway 12. As described in more detail below, at least a portion 27 of the bearing element 23 is made of a sealing material that is adjacent the pathway 12. In alternate embodiments, the bearing element 23 may be entirely made of a sealing material. The remainder of the bearing element 23 acts as a bearing surface that has a force exerted upon it by the spring 26. Most preferably, the bearing element 23 includes a sealing member 22 adjacent the pathway and a pin 26 adjacent the sealing member 22. The sealing member 22 is adjacent the pathway 12. The sealing member 22 should be larger than the pathway 12. By way of example to illustrate the meaning of “larger”, if the sealing member 22 and the pathway 12 are both circularly shaped, the diameter of the sealing member should be greater than, and thus larger than, the diameter of the pathway.

The sealing member 22 is made from EPDM rubber, although other types of materials may be used such as elastomers, nitrile, and Buna-N., or any other type of material suitable for blocking the flow of fluid.

The pin 24 acts a surface against which the spring 26 is biased when the pressure relief valve 2 is in an unactuated state. Although not required, the pin 24 preferably has a receptacle 28 within which the sealing member 22 resides. In a preferred embodiment, the pin 24 is made of brass, although in other embodiments the pin may be made of other material such as those described for the valve insert and the adjustment member. Note that a width 25, or diameter, of the pin is smaller than the width 21, or diameter of the chamber 20. Preferably, the pin also includes a chamfer 29, thus further narrowing the width 25 of the pin.

The spring 26 is located adjacent the pin 24 and under normal conditions, when the valve 2 is in a non-actuated state, the spring 26 is under compression and bears against the pin 24 and the sealing member 22. Thus, under normal conditions the spring 26 biases the pin 24 and the sealing member 22 against the pathway 12. The sealing member thus acts as a seal between the pathway 12 and the chamber 20.

Preferably, the spring 26 is a stainless steel spring, although the spring may also be made of silicon steel, a spring steel, or other suitable material that reduces the occurrence of failures such as fracture or creep failures. The load of the spring will be dependent on the pressure relief requirements associated with the pressurized tire.

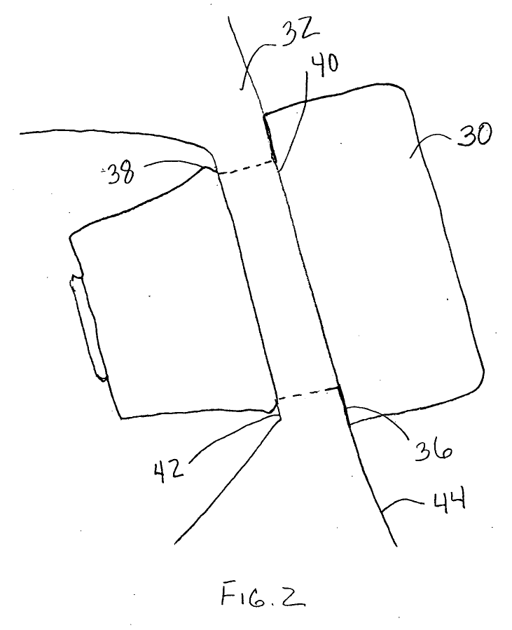

Referring also now to FIG. 2, a cushioning member 30 surrounds the valve insert 4 and prevents metal-to-metal contact between the valve insert 4 and a tire rim 32. The cushioning member includes a cavity 34 within which to receive the valve insert. The cushioning member also includes a flange 36 and an opening 38 that is in fluid communication with the pathway 12. When the pressure relief valve 2 is inserted into the tire rim 32, the flange 36 prevents the pressure relief valve from being completely inserted into the tire rim. A detent 39 on the cushioning member 30 prevents the cushioning member from being inadvertently separated from the tire rim due to vibrations, etc. experienced by the tire.

The cushioning member is preferably made from EPDM rubber, although other suitable materials may be used such as natural rubbers or synthetics. The cushioning member will be formed via an injection molding process.

The pressure relief valve 2 is attached to the tire rim 32 by being inserted through an opening 40 in the tire rim until the detent 39 passes an inner wall 42 of the tire rim, thus allowing the pressure relief valve to “snap” into place. The tire rim 32 also includes an outer wall 44. When the pressure relief valve 2 is inserted through the opening 40 in the tire rim 32, it is positioned so that the flange 36 is in contact with and on the same side as the outer wall 44 of the tire.

The tire rim preferably is a steel tire rim, although any suitable metal, commonly aluminum or magnesium, may be used.

The pressure relief valve operates as follows. The pressure within the tire enters the throughway 7 and into the chamber 20 and applies a force against the sealing member 22 and pin 24. When the pressure in the tire rises to the predetermined pressure, the pressure against the sealing member 22 and pin 24 will exceed the load of the spring 26. The spring 26 will thus be further compressed and the sealing member 22 and pin 24 will no longer biased against the pathway 12. The excess pressure will be able to pass from the chamber 20 and exit out the pathway 12 and opening 38.

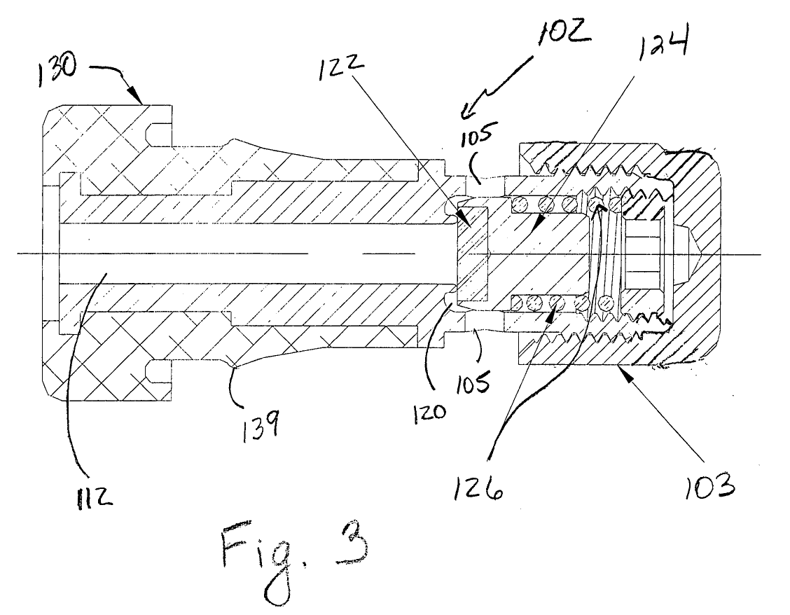

FIG. 3 shows an alternate embodiment of the pressure relief valve 102. The pressure relief valve of this embodiment is similar to the pressure relief valve of FIG. 1, with differences being noted below.

The pressure relief valve 102 includes a cap 103 on the adjustment member 106. The cap 103 assists in preventing tampering with the adjustment member 106, and typically is affixed via LOCKTITE, although in other embodiments other affixing methods known in the art may be used. The cap is made of brass, although other materials such as aluminum, or other suitable metals for that matter, may be used. Alternatively, the cap may be made from a heavier plastic.

A cushioning member 130 surrounds the valve insert 104 and prevents metal-to-metal contact between the valve insert 104 and a tire rim. The cushioning member includes a detent 139, which, as described above, allows the pressure relief valve to “snap” into place. The cushioning member is made from the same materials as described above.

The pressure relief valve 102 also includes a plurality of holes 105 that are preferably located adjacent to the cap 103. There are preferably four holes 105, although in other embodiments, one, two, three or more than four holes may be used. As is discussed further below, the holes 105 allow excess pressure to exit from the chamber 120 when the pressure in a tire rises to the predetermined pressure.

Operation if the pressure relief valve 102 is similar to that above. Pressure within the tire enters from the holes 105 and into the chamber 120, applying a force against the sealing member 122 and pin 124. When the pressure in the tire rises to the predetermined pressure, the pressure against the sealing member 122 and pin 124 will exceed the load of the spring 126. The spring 126 will thus be further compressed and the sealing member 122 and pin 124 will no longer biased in a direction opposite the spring 126. The excess pressure will be able to pass from the chamber 20 and exit out the pathway 112.

The use of the pressure relief valve with the cushioning member provides several advantages. First, although data regarding pressure is often provided by a remote tire pressure monitoring system, these systems often will not provide information regarding pressure when the tire pressure exceeds the predetermined pressure. Thus, no data regarding the tire pressure will be provided when the tire is over pressurized. Thus, the pressure relief valve will provide relief when the predetermined pressure is exceeded, thus helping to reduce any damage to the tire and/or the vehicle.

Moreover, the cushioning member prevents metal-to-metal contact between the valve insert and the tire rim. The use of dissimilar metals for the valve insert and the tire rim may cause galvanic corrosion if these two parts come into contact with each other. Galvanic corrosion is a problem in areas where large amounts of salt and slag are used on roads to melt snow and create traction. Thus, the use of the cushioning member provides an insulating barrier between the retention nut and the tire rim. Additionally, the cushioning member will help reduce any leaking between the opening in the tire rim and the pressure relief valve. Also, since the cushioning member surrounds the valve insert, the cushioning member will also help reduce incidents of tampering with the pressure relief valve.

Although the above description describes preferred embodiments, variations are also possible. For example, the position of the pressure relief valve may be reversed so that the flange of the cushioning member contacts the inner side of the tire rim and the detent contacts the outer side of the tire rim. Pressure from the tire then enters through the opening in the cushioning member and the pathway, applying a force against the sealing member and pin. When the pressure in the tire rises to the predetermined pressure, the pressure against the sealing member and pin will exceed the load of the spring. The spring will thus be further compressed and the sealing member and pin will no longer be biased against the pathway. The excess pressure will thus be able to exit out the throughway of the adjustment member. It is therefore intended that the foregoing detailed description be regarded as illustrative rather than limiting, and that it be understood that it is the following claims, including all equivalents, that are intended to define the spirit and scope of this invention.

1. A pressure relief valve, comprising:
a valve insert having an opening at a first end and a pathway extending towards the opening from a second end of the valve insert;
an adjustment member received within in the opening of the valve insert, the valve insert and the adjustment member defining a chamber adjacent the pathway, the adjustment member including a throughway;
a bearing element within the chamber and adjacent the pathway, a width of the bearing element being larger than a width of the pathway,
a spring within the chamber, the spring under compression and in line with the bearing element; and
a cushioning member surrounding the valve insert, the cushioning member allowing the flow of pressurized fluid;
wherein the spring exerts a force on the bearing element such that the bearing element is biased against the pathway and forms a seal between the chamber and the pathway.

2. The pressure relief valve of claim 1, wherein the bearing element includes at least in part a sealing member, the sealing member adjacent to the pathway.

3. The pressure relief valve of claim 2, wherein the bearing element further comprises a pin adjacent to the sealing member.

4. The pressure relief valve of claim 3, wherein the pin is adjacent the spring.

5. The pressure relief valve of claim 4, wherein the pin further includes a receptacle that receives the sealing member.

6. The pressure relief valve of claim 1, wherein the valve insert is made of brass.

7. The pressure relief valve of claim 1, wherein the valve insert includes interior threads and the adjustment member includes exterior threads that engage with the interior threads of the valve insert.

8. The pressure relief valve of claim 1, wherein the spring is made of stainless steel.

9. The pressure relief valve of claim 1, wherein the cushioning member is made of rubber.

10. The pressure relief valve of claim 1, wherein the cushioning member further comprises a flange and a detent for engagement with a tire rim.

11. The pressure relief valve of claim 1, wherein the cushioning member further comprises an opening in fluid communication with the pathway.

12. The pressure relief valve of claim 1, wherein a width of the bearing element is smaller than a width of the chamber.

13. A pressurized tire, comprising:
a tire rim;
a pressure relief valve attached with and in fluid communication with the tire rim, the pressure relief valve including:
a valve insert having a first end, at least one opening, and a pathway extending towards the opening from a second end of the valve insert;
an adjustment member received within a cavity of the valve insert, the valve insert and the adjustment member defining a chamber adjacent the pathway, the adjustment member including a throughway;
a bearing element within the chamber and adjacent the pathway, the bearing element being larger than a width of the pathway,
a spring within the chamber, the spring under compression and in line with the bearing element; and
a cushioning member surrounding the valve insert, the cushioning member allowing the flow of pressurized fluid;
wherein the spring exerts a force on the bearing element such that the bearing element is biased against the pathway and forms a seal between the chamber and the pathway.

14. The pressurized tire of claim 13, wherein the cushioning member further comprises a flange that contacts an outer wall of the tire.

15. The pressurized tire of claim 13, wherein the cushioning member further comprises a detent that contacts an inner wall of the tire.

16. The pressurized tire of claim 13, wherein the cushioning member further comprises a flange that contacts an inner wall of the tire.

17. The pressurized tire of claim 13, wherein the cushioning member further comprises a detent that contacts an outer wall of the tire.

18. The pressurized tire of claim 13, wherein the valve insert includes interior threads and the adjustment member includes exterior threads that engage with the interior threads of the valve insert.

19. The pressurized tire of claim 13, wherein the valve insert is made of brass.

20. The pressurized tire of claim 13, wherein the spring is made of stainless steel.

22. The pressurized tire of claim 13, wherein the at least one opening further comprises four openings to allow the flow of fluid into the chamber.

23. A method for inserting a pressure relief valve into a tire comprising:
inserting a pressure relief valve having a cushioning member into an opening of a tire rim;
passing a detent of the cushioning member past an inner wall of the tire rim; and
contacting a flange of the cushioning member with an outer wall of the tire rim.
